(19) United States
(12) Patent Application Publication
(10) Pub. No.: US 2007/0250350 A1
(43) Pub. Date: Oct. 25, 2007

(54) Method and apparatus for administrating metered insurance coverage

(76) Inventor: Greg Dillard, Bethlehem, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 10/871,665

(22) Filed: Jun. 18, 2004

Related U.S. Application Data
(63) Continuation-in-part of application No. 10/307,000, filed on Nov. 27, 2002.
(60) Provisional application No. 60/363,521, filed on Mar. 13, 2002.

(51) Int. Cl. G06Q 40/00

(52) U.S. Cl. 705/4

(57) ABSTRACT

A method and apparatus of administrating a builders risk insurance program with a computer system wherein builders may initiate coverage for individual building projects as they are begun from remote terminals by entering data on each project into a production scheduler that communicates with a central computer system that aggregates active building projects for determination and payment of metered builder's risk insurance coverage.

This application is a continuation in-part of co-pending application Ser. No. 10/307,000, filed Nov. 27, 2002, claiming priority benefit of provisional patent application Ser. No. 60/363,521 filed Mar. 13, 2002, incorporated herein by reference.

### TECHNICAL FIELD

The present invention relates to the administration of builder's risk property insurance. More particularly, the present invention relates to the automated metered administration of builder's risk property insurance for multi tasks building projects.

### BACKGROUND OF THE INVENTION

Professional builders are usually not self insured but rather purchase insurance to cover risks of loss or damage to buildings as they are being constructed. They also usually borrow the funds needed for construction from lending institutions which also require risk protection. This mandates that the builder or general contractor usually secure an insurance policy from an insurance company for each building project, notify the insurance company of the amount of coverage required as each project progresses and becomes more valuable, thus requiring increasing levels of financial protection, pay the premiums due periodically, and maintain records. Due to the ever changing dynamics of such insurance programs, their administration is relatively burdensome on all parties involved in comparison to more static insurance programs such as personal property insurance and life insurance. Indeed, some builders may have 50 or more buildings on different lots at various stages of development at any one time within a single subdivision.

Heretofore, insurance companies issued a separate policy to the builder for each of the particular construction projects. The lender is shown as loss payee. Generally, the term of the loan is relatively short (as compared to a 20 year mortgage). There are a large number of individual policies. For large contractors, the insurance company may agree to underwrite blanket insurance. However, there is a lack of uniform insurance coverage related to the value of the construction and the value of the advanced loan proceeds. The builder typically makes the arrangements for the loan from the lender and also makes arrangements for the collateral loan insurance. This creates a high level of dependency on the builder to initiate and maintain insurance coverage, while the circumstances are such that the lender is the party most at risk. The current lending/borrowing/insuring mechanism is inefficient, and exposes the lender to significant risks of loss. Also, the insurer provides builder risk coverage for construction activities that experience changing value as the project commences from a cleared building lot to a completed building ready for sale and closing. The builder may undertake a greater number of projects than contemplated, and the insurer thereby may be incurring greater loss risks than expected. At annual audits, the insurer may find that the risk exposure was significantly greater than the coverage paid for. In such circumstances, the contractor owes the insurer additional premiums for the incurred actual risk exposure exceeding that contemplated. The additional premiums may be difficult to collect.

It thus is seen that a need exists for an automated method of administrating insurance coverage for multi tasks building projects. It is to the provision of such that the present invention is primarily directed.

### SUMMARY OF THE INVENTION

The present invention meets the need in the art for a computer automated method of administrating and metering an insurance program for multi tasks building projects, in which the centralized apparatus enables builder to initiate, report and confirm insurance coverage on building projects being constructed under a single blanket builder's risk policy from a third party insurer to the builder that tracks building projects using a production scheduler. The method is useful for example in providing and maintaining insurance for housing developers as they build and sell individual houses on individual lots of residential subdivisions.

In a preferred form of the invention, master insurance policy data is entered into a central computer of a computer system that includes building parameters such as geographic data, building size and lender identification from which date premiums may be computed for specific building projects of a designated builder. The builder enters specific data on a specific building project from a remote terminal of the computer system directly or through communication with the central processor and the builder's production scheduler that tracks construction progress of building projects for the builder. The central computer then computes the premium for that project which is displayed at the remote terminal. The builder himself may then initiate insurance coverage on that project by entering acceptance from the remote terminal.

In another aspect, the present invention meets the need in the art by providing an apparatus for administrating a builders risk insurance program with a computer system that includes a central computer that is accessible from at least one remote terminal. An insurer issues a master builders risk insurance policy to a builder. A central computer system having a building projects database maintained by the insurer includes a plurality of building parameters for a specific building project of the builder to be covered by the master builders risk insurance policy. A remote terminal accessible by the builder is used to enter building parameters on the specific building project into the computer system. The computer system computes the insurance premium for the specific building project using the building parameters and displays the premium at the remote terminal. The builder selectively initiates builders risk insurance coverage under the master builders risk insurance policy for the building project by acceptance entry from the remote terminal.

Objects, features, and advantages of the present invention will become apparent upon reading of the following detailed description in conjunction with drawing and the appended claims.

### BRIEF DESCRIPTION OF THE DRAWING

The drawing is a block diagram showing insurance coverage administered in accordance with the invention for several builders each of whom has a number of building projects in development that are at risk of loss or damage.

### DETAILED DESCRIPTION

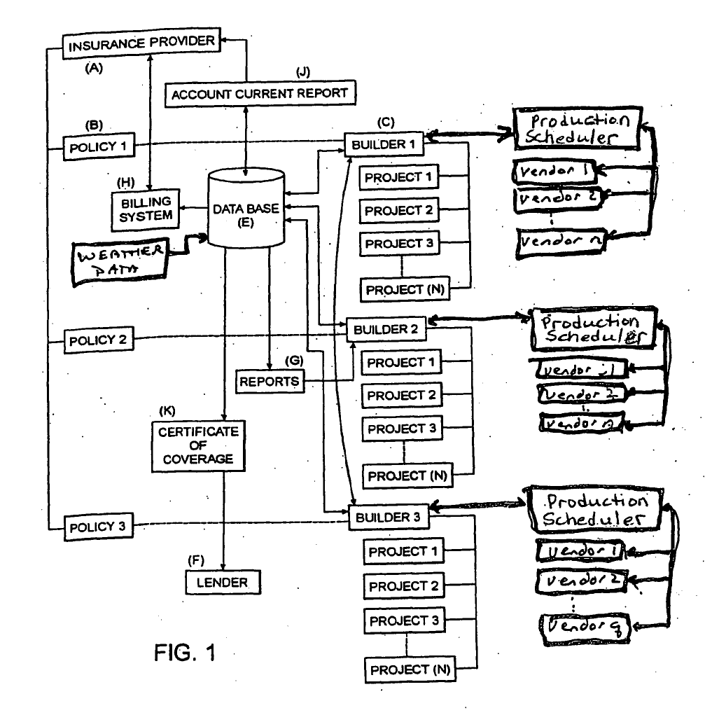

FIG. 1 generally illustrates use being made of the new administration method by a plurality of builders. Each builder is seen to have a number of building construction projects in progress. In this example each project of each builder is seen to be financed by a common lender and to be insured by a common insurance provider. However, the projects may be financed by distinct lenders. A master or blanket policy is issued to each of the builders in favor of the lender. The central computer is programmed to generate certificates of insurance coverages to the lender as new projects are begun and financed. It also periodically generates reports to the builders' computer terminals via the internet.

More specifically, the insurance provider issues a master policy to each builder in preparation for the provision of property insurance for projects as construction begins. Terms of the master or blanket policy are entered into the computer database. These terms include identification of the builders, the insurance providers and lenders, the policy numbers, and the effective dates. Premium rates, deductibles and limits on coverages are entered and a billing account number generated.

With this new administration method the builders themselves have direct access to the automatic system using their own computer terminal as via the internet, a wireless terminal device or telephone, or other computer communication device, to initiate coverage for each of their projects as they are started. To enable this upon purchase of their blanket policies they are issued user codes and passwords for this direct access.

To initiate coverage for a project a builder is prompted to enter the project location, the type of construction, such as brick or frame, the replacement cost of the building less land and land improvement costs, the size of the building, the number of stories and the name and address of the lender. This detailed building project information typically is initially entered by the builder to the builder's production scheduler that tracks the multi-tasks required to construct a building. In an alternate embodiment discussed below, the production scheduler subsequently communicates with the central computer and supplies the building specific project information.

Upon entry of the building project information, the central computer is programmed to compute premiums in accordance with the current terms of the blanket or master policy. In this regard territorial multipliers may add surcharges for hazardous locations such as along coastlines or geological fault lines, indexable as by zip code. The computed premium is displayed on the builder's terminals who may then activate coverage or choose instead to store the displayed information for possible later use.

Once project coverage is initiated under a blanket policy the computer generates a certificate of insurance coverage that is sent to the lender and to the builder. The timing for periodic reports is then initiated.

Preferably a credit card billing system is used for payment of the insurance premiums. Upon initiation of coverage the credit card insurer is issued access codes and notified of project identifications and premium charges along with the insured's billing account number. The billing service credits premiums less its own fee to the central computer and issues periodic statements that list all the insured projects and their premiums to the builder for payment. Premiums are periodically paid to the insurer. Premiums can also be made by electronic funds transfer from the builder's account containing draw-down funds for construction projects to a premium payment account of the insurer. A reporter generates reports of the insured projects and transfers of premium and communicates these reports to the insurer and the builder.

The administration method may also include hazardous weather tracking information and automatically suspend acceptance of new projects in the affected area during hazardous conditions. Again, zip codes may be used for locations in this regard. Once a project is completed and the building sold, the insurer is notified and that project is deleted from coverage under the blanket policy.

It is to be appreciated that the project information entered by the builder to initiate builders risk insurance coverage according to the present invention is used in an alternate embodiment that further includes a construction scheduling system by which the builder schedules construction activities for the project and tracks construction progress and includes access to the construction scheduling system by vendors to coordinate and schedule delivery of goods and labor services for the project while preventing access by the vendors to the insurance-related data.

In this embodiment, the disclosed central computer interconnects via communications channels or networks such as with computer access devices with the builders and also directly to the production scheduler for the respective builder, while also communicating with the insurer providing the collateral risk policy covering loan proceeds from the lender drawn upon by the builder for constructing a plurality of building projects that are subject to risk of loss during construction.

Each building project tracked by the production scheduler has at least an associated start date and building value, and includes the building site specific information described above. The builder operates the production scheduler to track a construction process for a plurality of projects that are subject to risk of loss during construction. Periodically, the builder updates the production scheduler with the progress of construction enabling sequencing of delivery of materials and attendance by vendors and contractors handling the various tasks associated with the construction. Upon completion of the particular project, the builder terminates tracking by entry of a close or sale date for the project. The builder draws on the funding account that holds the loan proceeds from the lending institution.

The central computer includes an analyzer that periodically interrogates the production scheduler to determine a construction status of each of the plurality of building projects for the builder. Thus, the central computer maintains a current status of the projects. The analyzer periodically aggregates the building values of projects under construction based on the project having a start date and not having a sold date. The analyzer then applies insurance rating values to the aggregated amount to determine a premium. The premium is based on a predetermined period, for example, a daily determination. This is accomplished by applying a premium rate factor for the particular builder to the aggregate building value. It is to be appreciated that in an alternate embodiment, the central computer periodically interrogates the production scheduler of the builder to aggregate building value rather than maintain building project date on a separate database of the central computer.

The periodic premium can then be transferred from the funding account to an account of the insurer. This can be accomplished in an aggregated manner by accumulating the periodic premium as a sub-period amount, for example, a daily amount accumulated over a one month period to yield a monthly premium based on the builder's daily actual construction status. Nevertheless, the central computer transfers an amount equal to the determined premium from the funding account to the payment account of the insurer. An alternate payment mechanism involves the use of payment and collect by charge card account, as discussed above.

Upon completion by sale or other disposal of the project, the builder updates the production scheduler. This information communicates to the central computer and the analyzer thereafter does not include the particular completed project when determining the periodic premium. The premium thus determined by the analyzer is based on active building projects of the particular builder during the period for which a premium is being determined.

The practice of the present invention accordingly involves a method of metering (during selected predetermined periods) a premium payment payable to the insurer issuing the collateral risk policy. The builder draws on the loan proceeds from the lender for constructing the plurality of projects that are subject to risk of loss during construction. The builder enters building construction information to the production scheduler that tracks construction of projects for the builder, and particularly including the building start date, location, and building value for each new project that is subject to insurance coverage through the collateral risk policy. The production scheduler communicates this building start information to the central computer. Periodically, for example, daily, the central computer makes a determination of the periodic premium. This is accomplished by applying a premium rate factor to the aggregate of the building values of the plurality of projects tracked by the production scheduler as being under construction during a predetermined period. The central computer then transfers a monetary amount equal to the determined premium from an account, such as the loan proceeds account for the builder, to the coverage payment account for the insurer. This transfer can be accomplished on the same period as the determination of the premium, or alternatively, periodic premiums can be collected as sub-periods to a greater period. For example, daily determined premiums can be collected and the transfer made monthly.

The builder periodically enters project update information to the production scheduler. This includes particularly a sold date for a particular one of the projects. This shows the project to the production scheduler (and to the central computer) as a project as no longer under construction and thus no longer at risk for loss to the builder. The production scheduler accordingly does not include the building value of that completed project in subsequent determinations of aggregate building values. However, the central computer repeats the steps of aggregating the project values and determining the periodic risk coverage premium based on the buildings at risk during the period, while initiating coverage for new projects commenced by the builder and ceasing to include projects marked as sold. The present method thereby meters the premium for collateral risk coverage based on based on projects under construction during the period. A reporter device interacts with the central computer and the projects database to provide status reports to the insurer, the lender, and the respective builders.

It thus is seen that a method is now provided whereby builders may secure metered insurance coverage for projects online on an automated basis with advance knowledge of the cost involved. The computerized method administers the insurance program automatically and continuously makes adjustments for changing coverage, premiums and reports as projects are added and deleted by the builders. Although the administration method has been described in its preferred form, it should be understood that modifications, additions and deletions may be made thereto without departure from the spirit and scope of the invention as set forth in the following claims.

What is claimed is:

1. A method of metering during selected predetermined periods a premium payment payable to an insurer for a collateral risk policy covering loan proceeds from a lender drawn by a builder for constructing a plurality of projects that are subject to risk of loss during construction, comprising:
(a) entering to a production scheduler that tracks construction of a plurality of projects a building project information for a new project subject to insurance coverage through a collateral risk policy;
(b) applying a premium rate factor to the aggregate of the building values of the plurality of projects tracked by the production scheduler as being under construction during a predetermined period to determine a premium for the period;
(c) transferring a monetary amount equal to the premium from a loan proceeds account for the builder to a coverage payment account for the insurer;
(d) periodically entering to the production scheduler a sold date for a particular one of the projects to show said project as no longer under construction, whereby the production scheduler does not include the building value of said project in subsequent step (b); and
(e) repeating steps (b) and (c) for subsequent periods, while conducting step (a) for additional ones of new projects and conducting step (d) for sold ones of the projects,
whereby the premium determined in step (b) is based on projects under construction during the period.

2. The method of metering as recited in claim 1, wherein the building project information comprises a project start date, a geographic location, and a building value.

3. The method of metering as recited in claim 1, further comprising the step of generating a stop coverage grant for at least one selected geographic area, whereby a new project within the selected geographic area is restricted from being included in the aggregate of projects for step (b).

4. The method of metering as recited in claim 1, wherein data on the weather predicated for a geographic area of a specific building project is entered into the computer system and updated and wherein step (d) the initiation of insurance coverage the specific building project is suspended while the weather data includes dangerous conditions data for said geographic area.

5. The method of metering as recited in claim 1 further comprising the step of generating a printed certificate of insurance coverage for the building project entered in step (a) following the aggregation of the building project in step (b).

6. The method of metering as recited in claim 1, further comprising the step of enabling a plurality of vendors to access the production scheduler for coordinating and scheduling delivery of vendor goods and services for the specific building project while restricting access by the vendor to the insurance coverage data.

7. An apparatus that meters a premium payment during a predetermined period to an insurer for a collateral risk policy covering loan proceeds from a lender drawn by a builder for constructing a plurality of projects that are subject to risk of loss during construction, comprising:
a production scheduler operative by a builder to track a construction process for each of a plurality of projects that are subject to risk of loss during construction, each project tracked by the production scheduler having project information on which insurance coverage premium can be determined;
a funding account of loan proceeds accessible by a builder for constructing the plurality of projects;
an analyzer that communicates with the production scheduler to determine a construction status of each of the plurality of building projects, aggregates building values of projects under construction based on the project having a start date and not having a sold date, and determines a premium for a predetermined period by applying a premium rate factor to the aggregate building value; and
means for transferring an amount equal to the determined premium from the funding account to an insurer payment account,
whereby the premium determined by the analyzer is based on projects under construction during the period.

8. The metering apparatus as recited in claim 7, wherein the building project information comprises a project start date, a geographic location, and a building value.

9. The metering apparatus as recited in claim 7, further comprising weather evaluating means for generating a stop coverage signal to restrict granting insurance coverage for a new project in a selected geographic area based on weather conditions.

10. The metering apparatus as recited in claim 7, further comprising a reporter that generates a printed certificate of insurance coverage for a new building project following the aggregation of the building project by the analyzer.

11. The metering apparatus as recited in claim 7, further comprising vendor communication means for a plurality of vendors to access the production scheduler to coordinate and schedule delivery of vendor goods and services for the specific building project while restricting access by the vendor to the insurance coverage data.

12. The metering apparatus as recited in claim 7, further comprising a communicator that periodically communicates project information from the production scheduler to the analyzer.

13. An interactive network selectively engagable by an insurer providing a collateral risk policy covering loan proceeds from a lender drawn by a builder for constructing a plurality of projects that are subject to risk of loss during construction metered as to predetermined periods, comprising:
a builder that tracks construction activities for a plurality of projects using a production scheduler that includes a start date, geographic lication, and building value for each of said projects;
a lender providing a source of funds account accessible by the builder periodically for construction of the projects;
an insurer providing a collateral risk coverage policy payable to the lender in the event of loss of a project during construction by the builder;
an analyzer that interrogates the production scheduler to determine a construction status of each of the plurality of building projects, aggregates building values of projects under construction based on the project having a start date and not having a sold date, and determines a premium for a predetermined period by applying a premium rate factor to the aggregate building value; and
means for transferring an amount equal to the determined premium from the source of funds account to an insurer payment account,
whereby the premium determined by the analyzer is based on projects under construction during the period.

14. The interactive network as recited in claim 13, further comprising a reporter operable by the insurer to determine a current amount of underwriting risk based on the aggregate building values of projects under construction.

15. The interactive network as recited in claim 14, wherein the reporter is accessible by the lender to report on projects under construction.

16. The interactive network as recited in claim 13, further comprising:
a risk assessor that evaluates underwriting risks at a plurality of locations to generate a stop coverage signal for selected locations; and
an access device operable by the insurer to stop acceptance of new projects to the production scheduler for insuring in the selected locations and to release for acceptance locations no longer subject to the stop coverage signal.

17. A method for a construction builder having a plurality of construction projects to initiate and monitor builders risk insurance with a central computer system accessible from a remote terminal, comprising the steps of
(a) obtaining by a builder a blanket coverage builders risk insurance policy for a plurality of building projects from an insurance provider having a central computer database of insurance policy terms from which insurance premiums may be computed for building projects of the builder;
(b) entering project data on a specific building project into a production scheduler;
(c) communicating the building project data to the central computer database of an insurer;
(d) computing an insurance premium for the aggregate of building projects for the builder; and
(e) communicating the initiation of insurance coverage for the specific building project.

18. The method of claim 17 wherein step (b) the builder enters geographic data and building value and size data for the specific project.

19. The method of claim 17, further comprising the step of suspending insurance coverage in a selected geographic area based on evaluation of weather for the selected geographic area.

20. The method of claim 17 further comprising the step of generating periodic reports that list all current projects subject of insurance coverage.

21. The method of claim 17 further comprising the step of generating a printed certificate of insurance coverage for the specific building project.

22. The method of claim 17 further comprising the step of terminating a selected one of the projects from the determination of the premium in step (d).

23. The method of claim 22, wherein terminating comprises the builder entering to the production scheduler sale information as to the selected one of the projects.

24. The method of claim 17, further comprising the step of enabling a plurality of vendor access the construction scheduler for coordinating and scheduling delivery of vendor goods and services for the specific building project while restricting access by the vendor to the insurance coverage data.
